(19) United States
(12) Patent Application Publication
(10) Pub. No.: US 2014/0126971 A1
(43) Pub. Date: May 8, 2014

(54) Readjustment System

(71) Applicant: Wolfgang Römpp, Hardt (DE)

(72) Inventor: Wolfgang Römpp, Hardt (DE)

(73) Assignee: Mauser-Werke Oberndorf Maschinenbau GmbH, Oberndorf (DE)

(21) Appl. No.: 14/128,025

(22) PCT Filed: Jul. 4, 2012
(86) PCT No.: PCT/EP2012/063046

§ 371 Date: Dec. 20, 2013

(30) Foreign Application Priority Data
Jul. 6, 2011 (DE) 10 2011 051 609.3

(51) Int. Cl. B23B 29/034

(52) U.S. Cl. CPC B23B 29/034
USPC 408/147

(57) ABSTRACT

There is disclosed a readjustment system comprising an advancing head supporting a cutting edge and being retained on a spindle. The cutting edge is advanced by means of an actuation element adjustable by a contactless linear drive.

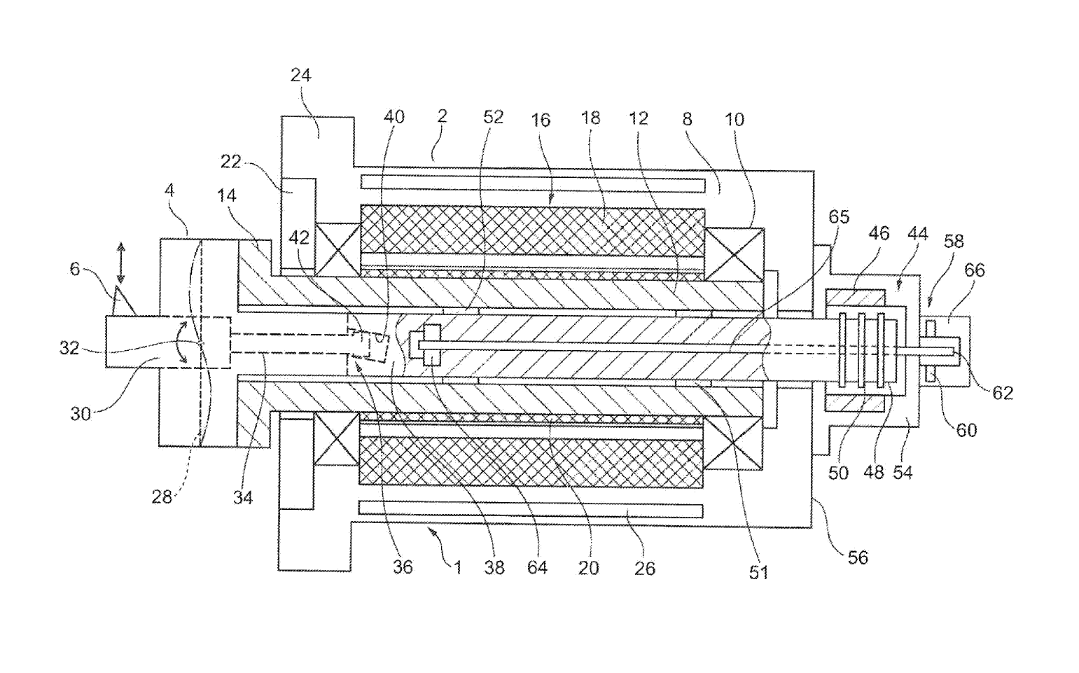

### BACKGROUND OF THE INVENTION

1. Field of the Invention

ill The invention relates to a readjustment system in accordance with the preamble of claim 1.

2. Description of Related Art

Readjustment systems of this type are used, for example, for readjusting in the case of wear of the tool or in the case of precision finishing of inner and outer contours of workpieces, wherein said contours can have a cylindrical, eccentric or out-of-round shape, for instance. DE 10 2007 017 800 A1 discloses a readjustment system in which a spindle supports a membrane tilting head by which a cutting edge is adjustable in the radial direction so as to impart a round, elliptic and/or trumpet shape in the longitudinal axis of the piston pin to a small connecting rod eye, for example. The membrane tilting head is adjusted via a linearly adjustable actuation element, also referred to as tie rod, via which a tool head supporting the cutting edge and being operatively connected to a membrane can be tilted with respect to the spindle axle so as to bring about the radial adjustment. The tie rod is supported in the spindle and co-rotates with the same. A rear end portion of the tie rod is guided out of the spindle and is supported there via a bearing arrangement on a slide adjustable via an actuator. In the known solutions the spindle is driven via a drive motor which is arranged in parallel to the spindle axle and is operatively connected to the spindle via a belt drive or the like.

It is a drawback of said solutions that considerable construction space and efforts in terms of apparatuses are required for the spindle drive as well as the bearing of the tie rod.

In DE 44 01 496 C3 an adjusting means for machining round, out-of-round and/or non-cylindrical contours is described in which the adjustment of a cutting edge is performed via a head including piezoelectric translators.

It is a drawback in this solution that considerable effort in terms of control is required to drive the piezoelectric translators, Moreover the adjustment travel is restricted in piezoelectric translators of this type.

### SUMMARY OF THE INVENTION

Compared to this, the object underlying the invention is to provide a readjustment system which requires reduced effort in terms of control while a compact structure is ensured.

This object is achieved by a readjustment system comprising the features of claim 1.

Advantageous further developments of the readjustment system are the subject matter of the subclaims.

These and other features and advantages of the invention will become apparent to those skilled in the art from the following description and the accompanying drawing. It should be understood, however, that the detailed description and specific examples, while indicating a preferred embodiment of the present invention, are given by way of illustration and not of limitation. Many changes and modifications may be made within the scope of the present invention without departing from the spirit thereof, and the invention includes all such modifications.

### DETAILED DESCRIPTION OF THE PREFERRED EMBODIMENT

In accordance with the invention, the readjustment system comprises an advancing head supporting at least one cutting edge or the like and being mounted on a spindle in which an actuation element adjustable approximately in the axial direction by an actuator is guided, the actuation element being operatively connected to the advancing head for radially adjusting the cutting edge. In accordance with the invention, the actuator is a contactless linear drive.

Due to this measure is it no longer required to support the actuation element on the rear sid—as in the state of the art as the actuation element is operatively or integrally connected to the adjustable part of the linear drive which, in turn, is movable relative to the non-adjustable part of the linear drive (stator) (runner) so that it is not important whether the runner is rotating or idling. By omission of the rear side support of the actuation element the entire adjustment system can be configured to be extremely compact with little effort in terms of apparatuses so that it can also be employed in small machining units.

In a preferred embodiment of the invention, the spindle is configured to have a direct drive which is arranged preferably coaxially with respect to the spindle axle. This further development permits to further minimize the construction space vis-à-vis the solutions having an axially parallel drive as described in the beginning. The integration of the spindle drive into the spindle itself and the use of a linear drive for actuating the actuation element enable the entire unit to be tested as to impact and strike and to be appropriately calibrated prior to mounting into the machining unit.

In such embodiment permanent magnets encompassed by a coil winding can be arranged on a spindle body.

In a variant of the invention, the linear drive is arranged on the rear side in the area of an end portion of the actuation element guided out of the spindle.

The readjustment system has a particularly simple design, when on the rear side a motor easing of the linear drive in which at least one stator winding is arranged is attached to the spindle, whereas a runner is connected to or integrally formed with the actuation element.

The linear drive is preferably configured to be excited by a permanent magnet.

In an embodiment of the invention, the actuation element is a tie rod by means of which the advancing head can be actuated for radial adjustment.

For controlling the stroke of the actuation element a measuring system can be provided by which the stroke is detected and is reported to a central control unit as an actual variable.

Such measuring system has an especially simple design when it is a magnetostrictive system.

In this case a waveguide of the measuring system can be supported in the actuation element and can bear an annular magnet. The pertinent converter member can be held on the rear side at the spindle.

In such embodiment it is preferred when the waveguide is passed through the motor casing of the linear drive and immerses into the converter member attached to the motor casing.

For minimizing inaccuracies due to thermal expansions and the like the annular magnet of the waveguide is preferably arranged in a cooled area of the advancing head.

in a preferred embodiment of the invention, the advancing head is in the form of a membrane tilting head.

The accuracy due to undesired thermal expansions of the components can be further improved, when the adjustment system is configured to include an integrated cooling.

Hereinafter, a preferred embodiment of the invention shall be illustrated by way of a single schematic drawing which shows a strongly simplified longitudinal section across a readjustment system according to the invention.

### DETAILED DESCRIPTION OF THE DRAWINGS

Accordingly, the readjustment system I according to the invention basically comprises a spindle 2 supporting an advancing head, in the illustrated case a membrane tilting head 4, by which a cutting edge 6 is adjustable in the advancing direction so that the geometries explained in the beginning, for example out-of-round, oval bores or bores configured to be trumpet-shaped in the bore axis of workpieces, for instance connecting rod eyes, can be precision finished. As a matter of course, instead of a membrane tilting head 4 also other advancing heads such as a parallelogram head, can be employed which permit adjustment of the cutting edge position during machining.

The spindle 2 includes a spindle housing 8 mounted on the machine tool or machining unit. In the spindle housing 8 a spindle body 12 is pivoted via a bearing arrangement 10. The membrane tilting head 4 is tensioned at a flange 14 at the end face projecting from the spindle housing 8. In the shown embodiment, the rotary drive of the spindle body 12 is performed via an integrated direct drive 16 which may be a synchronous or asynchronous motor, wherein one winding or more stator windings 18 are arranged in the housing, while magnets 20 of the direct drive 16 in the form of permanent magnets arc arranged on the outer periphery of the spindle body 12 so that, when the stator winding 18 is driven and when an appropriate moved rotating magnetic field is formed in the stator, the coil body 12 rotates at the speed set via the control. Instead of the permanent magnets, also solenoids can be used. The design of direct drives of this type is known per se so that further explanations are dispensable.

The stator winding 18 is accommodated in a coil body encompassing the magnets 20 which is inserted in the spindle body 12 and on which also the left and right bearings of the bearing arrangement 10 are supported in the axial direction. The bearings of the bearing arrangement 10 are otherwise supported on radial or axial shoulders of the spindle body, the left bearing in the figure being supported in the axial direction to the left on a front plate 22 which is inserted in a mounting flange 24 of the spindle body 8 protruding in the radial direction.

The axial support of the spindle body 12 is not shown in the schematic representation, in this context the existing prior art can be referred to. As is indicated in the figure, in the spindle housing 8 further a cooling 26 is integrated so that the readjustment system can be tempered to a predetermined temperature range and thus inaccuracies by thermal expansion of the components are minimized. The cooling 26 can be connected to the coolant/lubricant circuit of the machine tool/machining unit.

The design of a membrane tilting head 4 is known, for instance, from DE 10 2007 017 800 A1 cited in the beginning so that here only component parts essential to the invention shall be illustrated. Accordingly, the membrane tilting bead 4 includes a membrane 28 supported in the membrane tilting head 4 and being operatively connected to a tool head 30 so that in the case of deflection (dash-dot line) of the membrane 28 the tool head 30 tilts in the direction of arrow about an axis 32 and thus the cutting edge 6 is adjusted in the radial direction. Said tool head 30 is connected to a tie rod 38 via a pivot pin 34 indicated by a broken line and a link guideway 36. The tie rod includes at its tool head side end portion a forked groove 40 inclined with respect to the spindle axis into which a head 42 of the pivot pin 34 slightly extended in the radial direction immerses so that the latter is deflected about the axis 32 upon axial displacement of the tie rod 38 (to the left or the right in the figure) and thus adjusts the cutting edge 6 in the afore-described manner. As regards further details, the above-cited DE 10 2007 017 800 A1 is referred to.

The tie rod 38 is adjusted in the direction of the spindle axis in the shown embodiment by means of a linear drive 44 which may be, for example, a synchronous motor excited by permanent magnet. A stator of said linear drive 44 may include, for instance, a three-phase winding 46 indicated in the figure which basically consists of solenoid coils stacked on top of each other. A runner 48 or lineator of the linear drive 44 is configured in a way known per se to include a plurality of permanent magnets 50 and is either attached to the tie rod 38 or is formed integrally with the latter. The tie rod 38 and, resp., the runner 48 are guided with high precision via linear bearings 51, 52 in the spindle body 12. The runner 48 in the axial direction projects to the right horn the spindle housing 8 and immerses into an approximately cup-shaped motor casing 54 attached to the end face 56 located on the right in the figure. Accordingly, the linear drive 44 is an approximately cylindrical very compact unit that requires definitely less space than the constructional designs used in the state of the art in which the tie rod 38 co-rotating with the spindle body 12 has to be supported in the area of the drive—this is not necessary by reason of the contactless concept of the linear motor 44.

The adjustment of the runner 48 is performed by controlling the three-phase winding via the usual control means, for example PWM converters, so that an extremely high positioning accuracy can be attained.

For detecting the stroke position of the runner 48 and thus of the tie rod 38 a magnetostrictive measuring system 58 including a distance sensor is provided. The latter basically consists of a converter member 60 which is operatively connected with a waveguide 62 formed by a copper tube, for instance, that immerses in an axial bore 65 of the tie rod 38 and extends to the coupling of the membrane tilling head 4. A permanent annular magnet 64 in the form of an annular magnet in the shown embodiment is arranged at the tool head side end portion of the waveguide 62. A current pulse propagating in the waveguide 62 as a magnetic field is generated in the waveguide 62 by means of the converter member 60. The magnetic field of the permanent annular magnet 64 extends approximately perpendicularly to the magnetic field generated in the waveguide 62 by the current pulse so that the waveguide 62 is elastically deformed by superposition of the two magnetic fields. Said elastic deformation propagates in the waveguide 62, wherein the rate of propagation is very high. In the converter member 60 the mechanical pulse is converted into an electric signal and the travel time is calculated winch is required by said mechanical pulse from the place of origin, i.e. from the position of the permanent annular magnet 64 to the converter member 60. This travel time then is proportional to the distance between the permanent annular magnet 64 and the converter member 60 and thus proportional to the stroke of the tie rod 38. The converter member 60 is accommodated in a signal converter housing 66 attached to the end face of the motor casing 54, wherein the waveguide 62 passes through the latter and immerses into the signal converter housing 66.

Consequently, the stroke of the runner 48 and the tie rod 38, respectively, can be determined extremely exactly by means of the magnetostrictive measuring system 58; from a characteristic then the swiveling of the tool head 30 and thus the position of the cutting edge is appropriately determined so that an extremely precise machining is possible. As is shown, the waveguide 62 is configured to have a comparatively great axial length, wherein inaccuracies due to thermal expansions are minimized by positioning the permanent annular magnet 64 in the area of the cooling 26 and very close to the membrane tilting head 4.

Vis-à-vis the solutions described in the beginning, the described readjustment system excels by a very compact and simple design, with the machining accuracy being improved by increased rigidity of the readjustment system.

In the shown embodiment the tie rod 38 co-rotates with the spindle body 12, accordingly also the waveguide 62 co-rotates with the spindle body 12 however, due to the contactless linear drive 44 and also the largely contactless magnetostrictive measuring system 58 no complicated bearing of the driving and measuring system components is required, as already mentioned before.

There is disclosed a readjustment system comprising an advancing head supporting a cutting edge and being retained on a spindle. The cutting edge is advanced by means of an actuation element adjustable by a contactless linear drive.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. A readjustment system comprising an advancing head supporting at least one cutting edge and being retained on a spindle in which an actuation element adjustable approximately in the axial direction by an actuating drive is guided, the actuation element being operatively connected to the advancing head for radial adjustment of the cutting edge, characterized in that the actuating drive is a linear drive, wherein the spindle is configured to include an integrated direct drive arranged coaxially with respect to the spindle axle, and a measuring system is provided for detecting a stroke of the actuation element, wherein the measuring system is a magnetostrictive measuring system comprising a waveguide which is supported in the actuation element and on which a permanent annular magnet is arranged, wherein a converter member is retained on a rear side of the spindle.

2. (canceled)

3. The readjustment system according to claim 1, wherein magnets the direct drive are arranged on a spindle body and are encompassed by a stator winding.

4. The readjustment system according to claim 1, wherein the linear drive is arranged in the area of an end portion of the actuation element guided out of the spindle on the rear side.

5. The readjustment system according to claim 4, wherein on the rear side a motor casing is provided in is at least one stator winding is arranged while a runner of the linear drive is connected to or integrally formed with the actuation element.

6. The readjustment system according to claim 5, wherein the linear drive is excited by a permanent magnet.

7. The readjustment system according to claim 1, wherein the actuation element is a tie rod.

8-10. (canceled)

11. The readjustment system according to claim 1, wherein the waveguide is passed through the motor casing and immerses into the converter member attached to the rear side.

12. The readjustment system according to claim 1, wherein the permanent annular magnet arranged on the waveguide in the area of the advancing head.

13. The readjustment system according to claim 1, wherein the advancing head is a membrane tilting head.

14. The readjustment system according to claim 1, comprising a cooling.
